(19) United States
(12) Patent Application Publication
(10) Pub. No.: US 2010/0333149 A1
(43) Pub. Date: Dec. 30, 2010

(54) DELIVERY OF PRE-STATISTICALLY MULTIPLEXED STREAMS IN A VOD SYSTEM

(75) Inventors: Anesh Sharma, Santa Clara, CA (US); Yue Wang, San Jose, CA (US)

Correspondence Address: Lipsitz & McAllister, LLC, 755 MAIN STREET, MONROE, CT, 06468, US

(73) Assignee: RGB NETWORKS, INC., Sunnyvale, CA (US)

(21) Appl. No.: 12/814,843

(22) Filed: Jun. 14, 2010

Related U.S. Application Data
(60) Provisional application No. 61/269,495, filed on Jun. 24, 2009.

(51) Int. Cl. H04N 7/173

(52) U.S. Cl. 725/91

(57) ABSTRACT

Methods and apparatus are provided for delivering a plurality of video on demand (VOD) streams to customers. Video streams are received from a VOD server. The received streams are statistically multiplexed to transrate them and to optimize their video bandwidth. The statistically multiplexed streams are modulated, and then delivered to customers as single program transport streams.

This application claims the benefit of U.S. Provisional Application No. 61/269,495, entitled “Delivery of Pre-Statistically Multiplexed Streams in a VOD System,” filed Jun. 24, 2009, the contents of which are hereby incorporated by reference.

### BACKGROUND OF THE INVENTION

The present invention relates to digital video communication, and more particularly to the delivery of pre-statistically multiplexed streams in a video on demand (VOD) cable television system or the like.

In a VOD cable system, multiple VOD streams are delivered as Single Program Transport streams (SPTS) to the Quadrature Amplitude Modulation (QAM) modulators by the VOD servers, which are multiplexed by the QAM modulators over a fixed bandwidth channel and are then transmitted to set-top boxes/receivers over an RF carrier. A typical QAM modulated channel is a fixed bandwidth channel. In 256-QAM modulation mode, for example, this channel has a fixed bandwidth of around 38.8 Mbps. Typically each VOD stream is a constant bit-rate stream at around 3.75 Mbps for Standard Definition (SD) channels and 15 Mbps for High Definition (HD) channels.

With the growth of demand for VOD streams, which is typically one stream per customer at any given time, cable operators need efficient ways of delivering more VOD streams to customers. One way to deliver more channels is to improve the efficiency of video compression algorithms used to generate the VOD streams and lower the bandwidth allocated to each stream by generating Constant Bit Rate (CBR) streams which are less than 3.75 Mbps. In this case, every single VOD stream that is used in the install-base will have to be modified, which is quite expensive and cumbersome. It is also difficult to come up with algorithms that maintain the same video quality at a lower bit-rate.

Another way to increase the number of channels is to utilize Variable Bit Rate (VBR) encoding. In this case, the compression ratio is increased when a particular scene is simple and decreased when the particular scene is complex. But it is difficult to combine these VBR streams into multiplexes by QAM modulators, without running the risk of overflow on the fixed bandwidth QAM channels. One has to always make sure that the instantaneous bit rate of the combined streams does not exceed the capacity of the fixed bandwidth channel in order to avoid such overflow. In a VOD environment there is an additional complexity as the programs (e.g., movies) are pre-encoded and reside on the VOD servers. Thus, there is no prior knowledge of streams that will be combined and/or multiplexed on any given QAM channel, as this process is controlled by Session and Resource Managers (SRM).

It would be advantageous to provide a system for modifying and delivering such VOD streams seamlessly, while allowing a significant increase in the number of streams that can be delivered to subscriber receivers (e.g., set-top boxes). The present invention provides apparatus and methods having the aforementioned and other advantages.

### SUMMARY OF THE INVENTION

A method is provided for delivering a plurality of video on demand (VOD) streams to customers. In accordance therewith, video streams are received from a VOD server. The received streams are statistically multiplexed to transrate them and to optimize their video bandwidth. The statistically multiplexed streams are modulated, and then delivered to customers as single program transport streams.

In an illustrated embodiment, the streams received from the VOD server are unicast single program transport streams, and the transrated and optimized streams resulting from the statistical multiplexing step are provided for modulation as single program transport streams. The streams received from the VOD server can be delivered via a User Datagram Protocol (UDP) port. In such an embodiment, the transrated and optimized streams resulting from the statistical multiplexing step can then be provided for modulation as single program transport streams over the same UDP port.

The modulating step can utilize a portmap processing scheme to map multiple VOD single program transport streams delivered on different UDP ports to a specific QAM channel and allocate a unique program to each VOD stream based on the map. The portmap processing scheme can also be used by the statistical multiplexing step.

Apparatus is provided for delivering a plurality of video on demand (VOD) streams to customers. The apparatus includes a dynamic bandwidth manager (DBM) for receiving video streams from a VOD server. A statistical multiplexer within the bandwidth manager transrates the received streams and optimizes their video bandwidth. A modulator is provided for modulating the statistically multiplexed streams for delivery as single program transport streams.

The streams received from the VOD server can comprise unicast single program transport streams. In such an embodiment, the transrated and optimized streams from the statistical multiplexer can be provided to said modulator as single program transport streams.

The streams received from the VOD server can be delivered via a User Datagram Protocol (UDP) port. In such an embodiment, the transrated and optimized streams can be provided to the modulator over the same UDP port.

The dynamic bandwidth manager (DBM) can comprise a plurality of transraters. In an illustrated embodiment, an input buffer is associated with each transrater, and each input buffer is coupled to receive packets from an output of its associated transrater. A rate estimator is coupled to receive information from the input buffers and to provide feedback based thereon to the transraters. A packet scheduler provides packets from the input buffers at a predetermined transmission channel rate. In an illustrated embodiment, a program association table (PAT) generator is associated with the packet scheduler.

The DBM can further comprise a packet classifier for receiving the packets from the packet scheduler. A plurality of output buffers can be coupled to receive packets from the packet classifier, each output buffer being associated with a particular User Datagram Protocol (UDP) port. The packet classifier can route particular packets to particular output buffers based on the UDP port with which a stream carrying the particular packets is associated.

In an illustrated embodiment, each stream is carried via the UDP port associated with that stream to one of the transraters for processing. The packet classifier uses routing information tagged to each stream to place packets from the stream into the proper output buffer after statistical multiplexing and transrating operations have been performed on the stream.

Also in an illustrated embodiment, null packets are dropped from the packets from the packet scheduler before being provided to the output buffers.

The packets can be provided to the output buffers in a constant bit rate (CBR) transport stream. A program clock reference (PCR) restamp module and a null packet inserter can be associated with each output buffer and coupled to receive packets from the packet classifier for providing the packets at the constant bit rate.

### BRIEF DESCRIPTION OF THE DRAWINGS

FIG. 1 is a block diagram showing the distribution of programs from a VOD server to subscriber set-top boxes via a Hybrid Fiber Cable (HFC) network;

FIG. 2 is a block diagram illustrating the interaction of the various devices of FIG. 1;

FIG. 3 is a block diagram similar to that of FIG. 2 to which a transrating function has been added;

FIG. 4 is a block diagram illustrating the addition of a Dynamic Bandwidth Manager (DBM) for internal statistical multiplexing and a plurality of set-top boxes for receiving content;

FIG. 5 is a diagram illustrating an example DBM statistical multiplexer (transrater), and more particularly the input to the DBM transrater;

FIG. 6 is a diagram illustrating the output from the DBM transrater;

FIG. 7 is a block diagram illustrating the processing of a plurality of VOD streams in accordance with the invention; and

FIG. 8 is a block diagram of another implementation in which a plurality of VOD streams is processed in accordance with the invention.

### DETAILED DESCRIPTION OF THE INVENTION

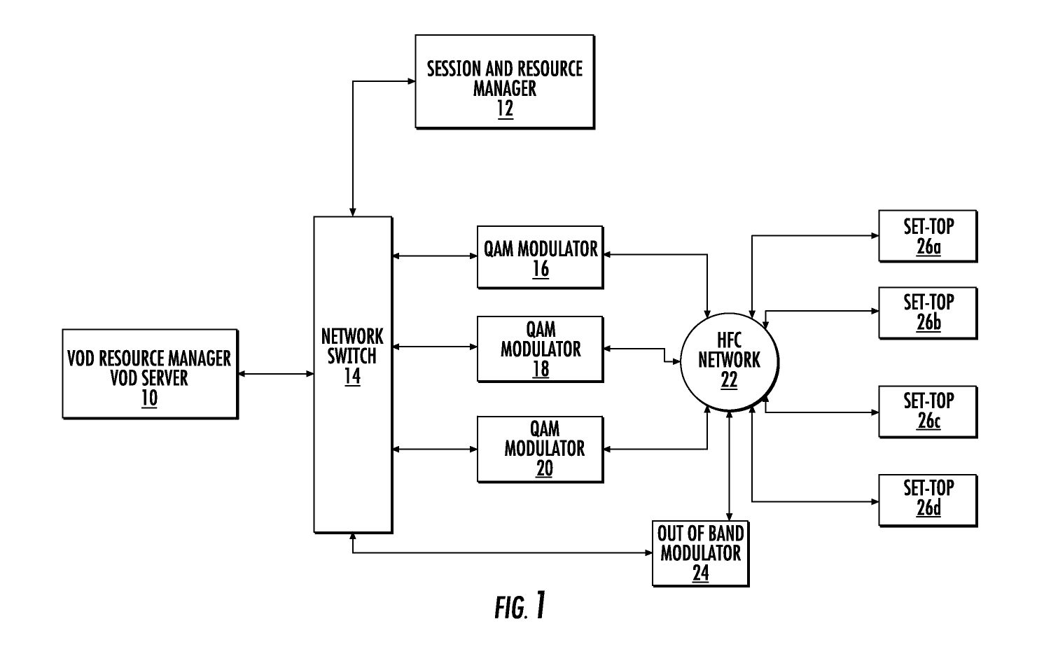

FIG. 1 is a diagram illustrating the delivery of VOD streams in a cable television system. Set-top boxes (receivers) 26 a, b, c, . . . n have a guide of all the VOD programming (mostly movies) available to them through a client application that runs on the device. The customer makes a selection of a particular VOD movie or content and the request goes to the session and resource manager SRM 12 via an out of band modulator 24. VOD programming selected by the customer is provided by the VOD Resource Manager/VOD Server 10. The programming is modulated for transmission by a QAM modulator (e.g., one of modulators 16, 80 or 20), which receives the program streams from the VOD server via a network switch 14. The selected programming is then communicated via the HFC Network 22 to the customer's set top box.

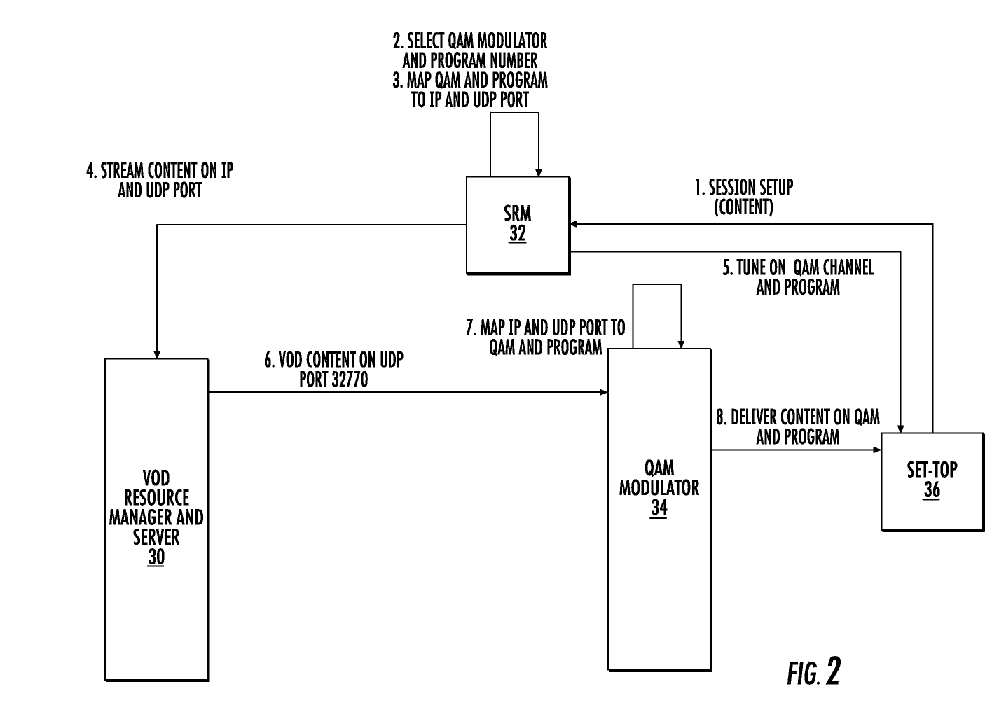

A high level description of the interaction among the various devices, which refers to FIG. 2, is provided below:
(1) A client on a Set-top 36 requests the SRM 32 to play particular content, such as a movie. The request goes to the SRM through the network e.g., an HFC network like that illustrated in FIG. 1. The SRM knows which content is requested and information regarding the set-top which requested it.
(2) Based on the information, the SRM 32 picks a QAM modulator 34 that has sufficient bandwidth available to route the new stream from VOD server 30. The selected QAM modulator 34 must also be capable of reaching the client set-top (topology/locale configuration) that requested the content. The SRM 32 will also pick an available Motion Picture Experts Group (MPEG) program number or service ID. The MPEG program number is needed by the set-top 36 to identify the content from a QAM channel that carries a multiplex of MPEG programs or VOD content meant for multiple customers.
(3) The SRM 32 does not have to communicate with the QAM Modulators. Instead, the SRM relies on a pre-defined or configured stream-map to route the stream. In one example implementation, content delivered to a particular User Datagram Protocol (UDP) port is mapped to a QAM channel and an MPEG program number in a predefined or configurable way (“static configuration”). It is noted that the UDP port numbers shown in the drawings are for illustration only, and are not to be considered limiting in any way.
(4) The SRM 12 then tells the VOD resource manager or VOD Server 30 to stream the content to the QAM device 34 by providing the Internet Protocol (IP) address of the QAM data port. Typically, a gigabit Ethernet port is used for this purpose, but other types of ports known in the art could be used instead as long as a suitable bandwidth is provided. The SRM also assigns a particular UDP port to carry the selected stream.
(5) The SRM then provides the set-top box or receiver 36 with the QAM channel number and MPEG program to allow the set-top to tune to the content for decoding and display.
(6) The VOD Server 30 streams the content over, e.g., a gigabit Ethernet interface using the IP and UDP port provided by the SRM. It sends the constant bit rate (CBR) transport stream which contains only one program (Single Program Transport Stream—SPTS).
(7) The QAM modulator 34 receives the SPTS from the VOD server and maps it back to the QAM channel and MPEG program after multiplexing the stream. It transmits a CBR multiplex which contains multiple programs. This way, the same QAM channel is used for delivering content to multiple clients or set-tops. In a sense, the QAM device acts as multiplexer as well as a modulator.

In this illustrated example, assuming a bit rate of individual content at 3.75 Mbps and a fixed QAM channel bandwidth of around 38.8 Mbps, the SRM will be able to accommodate around ten VOD channels. In other words, one QAM channel can serve up to ten customers (3.75 multiplied by 10 is equal to 37.5 Mbps, which fits within the 38.8 Mbps channel bandwidth). The QAM modulators basically take multiple SPTS (ten in this example) and multiplex them into a Multiple Program Transport Stream (MPTS) which is modulated and sent over an RF channel using an HFC network.

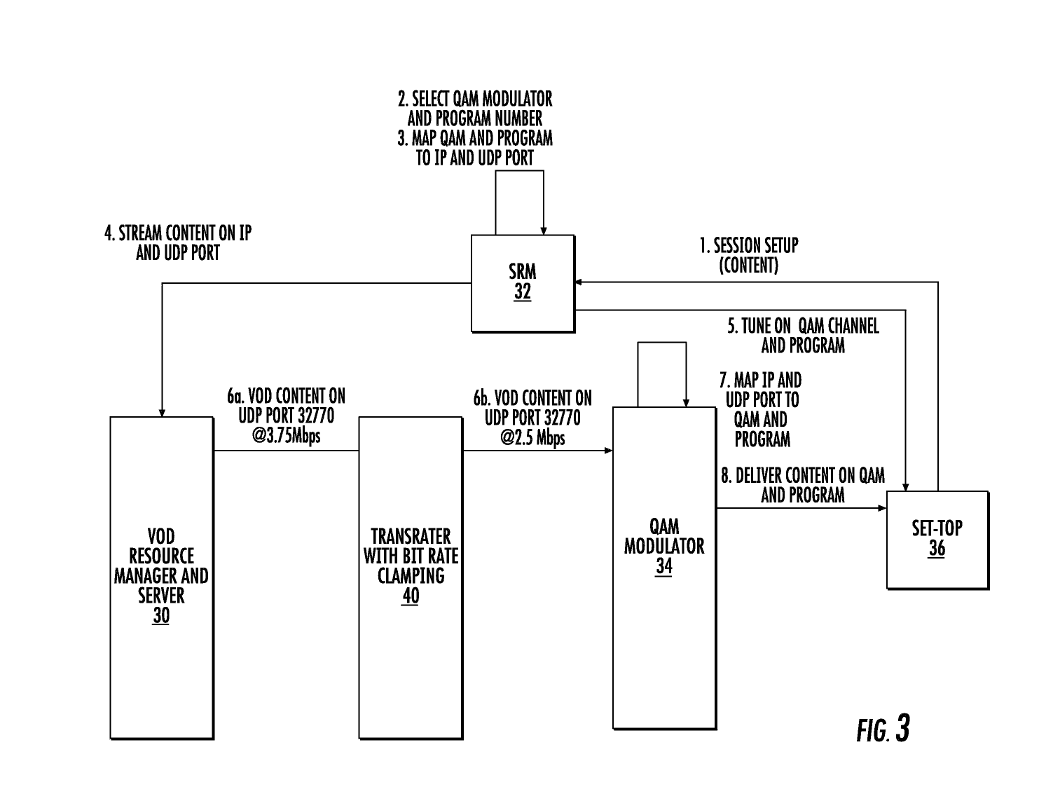

In order to increase the number of channels in real time, without re-encoding the VOD streams on the server, a multiplexer or a device that includes transrating capability can be utilized to save the bandwidth required by individual streams. These devices are often referred as statistical re-multiplexers. Such a device can be placed in between the VOD server and the QAM modulation device, as illustrated in FIG. 3.

In one design, a transrater 40 can take an SPTS in at 3.75 Mbps, clamp or re-quantize it to 2.5 Mbps (2.5 Mbps is the output transport bandwidth), and transmit the SPTS to the QAM modulation device 34. Functionally, this is similar to changing the bit rate of the VOD streams by re-encoding. However, this solution does not result in optimal quality as it does not take advantage of statistics of other content that will be multiplexed with this content in a downstream QAM device (not all content will require the high bandwidth at the same time).

In another approach, the device 40 can act as a transrater/statistical multiplexer as described in commonly owned U.S. Patent Publication 2008/0068997 published on Mar. 20, 2008 and incorporated herein by reference. In such an implementation the transrater 40 can statistically multiplex the incoming streams to optimize the quality of video by taking advantage of the fact that these streams will be delivered over a fixed bandwidth channel and grouping them together to form a multiplex. In such a scenario, transrater 40 can output a Multiple Program Transport Stream (MPTS) at around 38.8 Mbps which could be delivered to QAM device 34 to pass the MPTS through without changing it. This can be accomplished, e.g., by only modulating the MPTS to generate a signal for radio frequency (RF) distribution. The issue is that this would require all the QAM devices to pass through the MPTS (just providing the QAM modulation without multiplexing), which is not the typical case in a VOD environment.

In a VOD environment, devices deal primarily with unicast SPTS's which are targeted to a specific customer and are mostly multiplexed together by the QAM device at the edge of the network. Having just an ability to pass through the MPTS on the QAM device limits the capabilities of the QAM devices as far as any other functions that the QAM device might intend to invoke. This might require the QAM device to support “pass through” functionality which might not be the case with certain QAM devices already being used in the field. One example is the “encryption” function inside the QAM device that might need the incoming streams to be a unicast SPTS stream. Under such conditions, the transrater device cannot send a MPTS. There could also be other processing devices in the VOD environment that might want to process the unicast VOD SPTS stream (e.g., an encryption function can reside in a different device and not necessarily a QAM device).

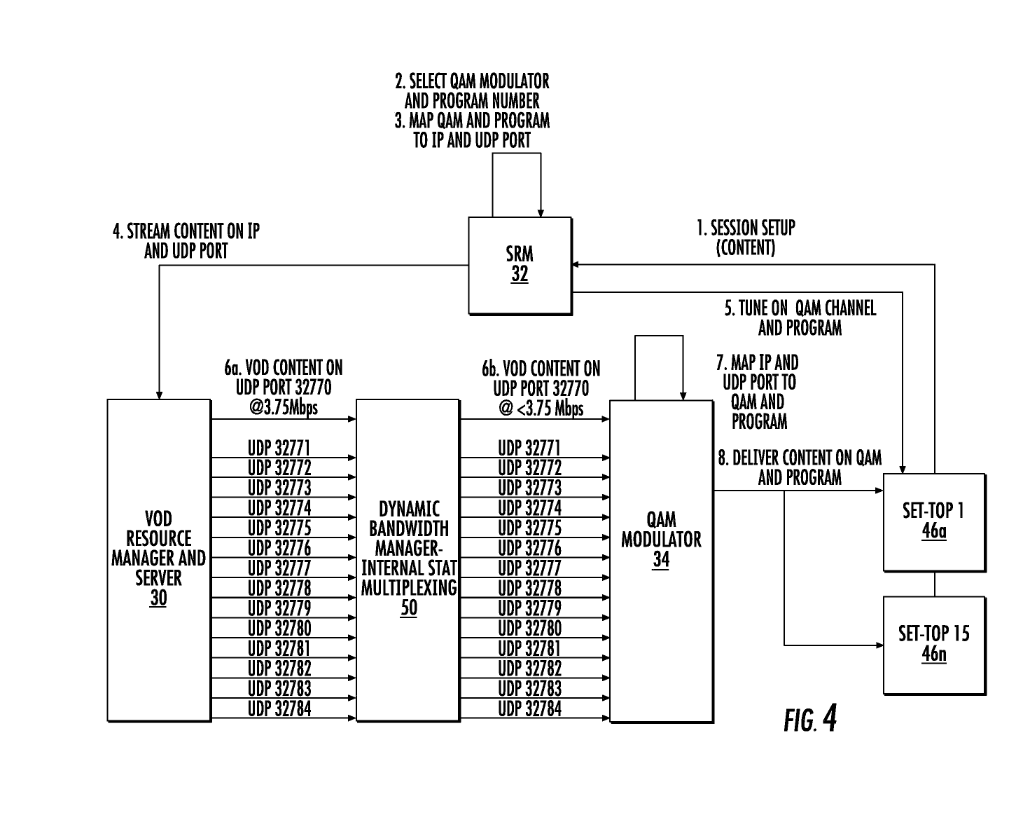

The present invention allows the transrater to be fairy independent of the network configurations and still deliver a pre-statistically multiplexed SPTS to the QAM device. In particular, instead of a transrater 40 as shown in FIG. 3, a “Dynamic Bandwidth Manager” 50 is provided in accordance with the invention between VOD server 30 and QAM device 34, as shown in FIG. 4. The Dynamic Bandwidth Manager (“DBM”) 50 takes incoming unicast single program transport streams, provides statistical multiplexing to transrate them and to optimize the video bandwidth, and still deliver them as SPTS's over the same UDP port.

Existing QAM devices use a scheme to map multiple VOD SPTS's delivered on different UDP ports to a specific QAM channel and allocate a unique MPEG program to each VOD stream based on this map. In accordance with the present invention, the Dynamic Bandwidth Manager takes advantage of this scheme and “pre-stat-muxes” the VOD streams together, while still delivering them as individual SPTS' on the output. The UDP portmap scheme of the QAM device can be configured and defined on the DBM as well. The QAM devices are therefore unaware of the presence of such a device before it. This method also allows such devices to be placed seamlessly in the existing VOD environment with minimum changes to the set-up and configuration.

In the example illustrated in FIG. 4, bandwidth efficiency can be as much as 50% (Cumulative input bit rate=15*3.75=56.25 Mbps). This cumulative bit rate of 56.25 is transrated to 38.8 Mbps, which is equivalent to the QAM bandwidth. The individual streams are converted from CBR to VBR by the transrater. The instantaneous bit rate of the combined streams at any time does not exceed the fixed QAM channel bandwidth, allowing the QAM device to re-multiplex them over an RF channel.

From a configurations perspective, the SRM 32 needs to be configured for a higher fixed channel bandwidth (56.25 Mbps). This will allow the SRM to route and allocate more streams to the QAM device since the bandwidth management and QAM selection process is a function of the SRM 32. This selection process is usually based on available bandwidth on any given QAM modulator 34 when multiple QAM modulators are available for the SRM to chose from.

The operation of the system described in connection with FIGS. 2, 3 and 4 is summarized by the numbered process steps set forth in these figures. In FIG. 2, these steps are:
1. Session Setup—where certain content is requested by a user via his/her set-top box.
2. Select QAM Modulator and Program number at SRM
3. Map QAM and Program to IP and UDP Port at SRM
4. Stream Content on IP and UDP port from SRM
5. Tune (set-top) to QAM channel and desired program
6. VOD content is provided on a particular UDP port from VOD Resource Manager and Server
7. Map IP and UDP Port to QAM and Program at QAM Modulator
8. Deliver content (to set-top) via QAM

FIG. 3 expands step 6 into steps 6a (after the VOD Resource Manager and Server 30) and 6b (after the Transrater 40), namely:
6a. VOD content is provided on a particular UDP port at 3.75 Mbps. Note that this bit rate is for purposes of illustration of a preferred embodiment only, and is not meant to be limiting.
6b. VOD content on the UDP port is provided from the transrater at 2.5 Mbps. Again, the stated bit rate is for purposes of illustration only, and is not meant to be limiting.

FIG. 4 expands step 6 into steps 6a (after the VOD Resource Manager and Server 30) and 6b (after the Dynamic Bandwidth Manager 50), namely:
6a. VOD content is provided on a particular UDP port at 3.75 Mbps. Note that this bit rate is for purposes of illustration of a preferred embodiment only, and is not meant to be limiting.
6b. VOD content on the UDP port is provided from the DBM at <3.75 Mbps. The stated bit rate is for purposes of illustration only, and is not meant to be limiting.

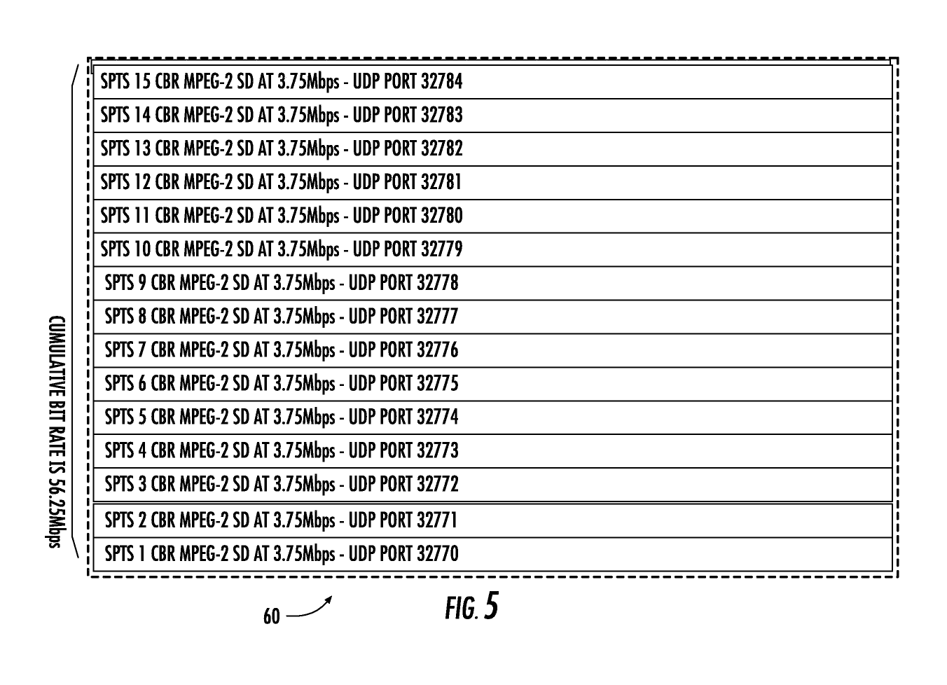

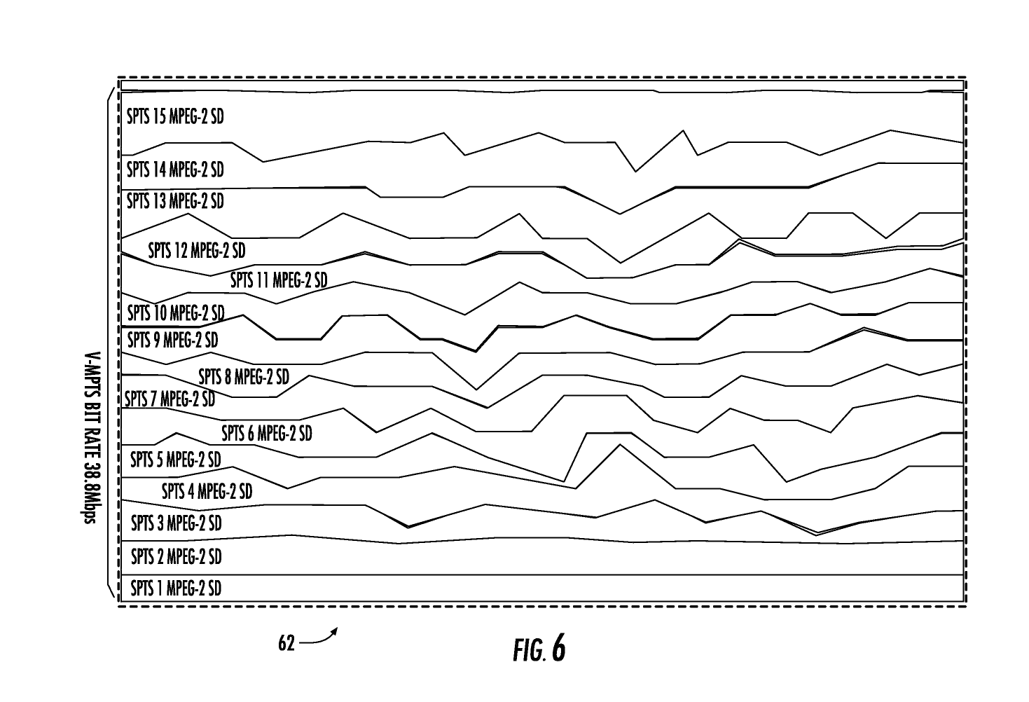

An example diagram of a DBM statistical multiplexer is shown in FIGS. 5 and 6. The individual bit rates are changed from CBR processing as shown at 60 in FIG. 5 to VBR as shown at 62 in FIG. 6. As indicated in FIG. 6, the cumulative bit rate at the output of transrating (V-MPTS Bit Rate) is maintained at 38.8 Mbps.

Many different algorithms exist that could be used to transrate the video streams using statistical multiplexing techniques. In a VOD system, system latency or end to end processing delay added by any device needs to be very small, on the order of milliseconds. This is required as the VOD system provides interactive functionality to the set-top client or customer, especially for trick play operations such as fast-forward (FF), rewind (REW) and PAUSE. If there are devices/multiplexers/transraters that add high system latency, the user experience for trick play functionality is affected. VOD trick play functionality mimics a VCR like operation, and hence the response time and stream latency needs to be kept to a minimum. The transrating algorithm described in the above-referenced U.S. Patent Publication 2008/0068997 can be extended and utilized to “pre stat mux” the VOD streams, as it can be set to a desired “system latency.”

System latency may be accounted for when converting the proximity factor PF to the global Q. Accounting for the system latency may comprise determining a latency factor LF for the system latency, and calculating the global Q using the formula:

Q=((LF−PF)*N)/LF

The latency factor LF may be defined as LF=Constant*Latency. Looking at the algorithm, desired transrating for VOD systems can be achieved by keeping the system latency to a minimum, thus allowing a adjustable Latency Factor LF.

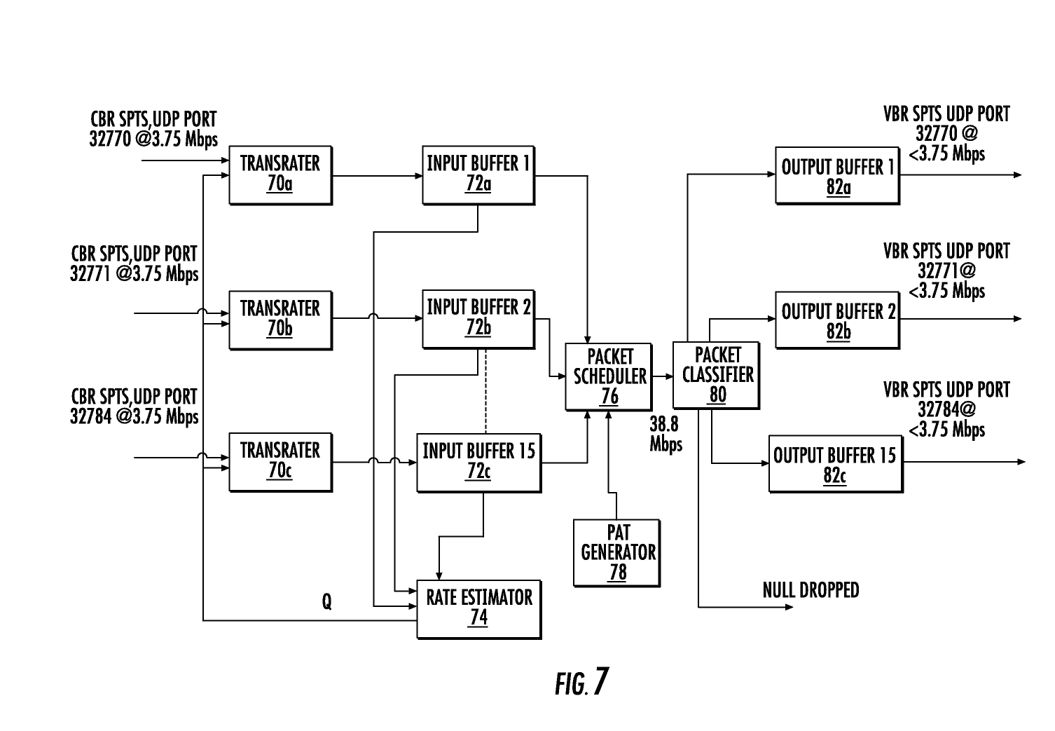

FIG. 7 is a block diagram illustrating the use of a plurality of transraters 70a, 70b, 70c with corresponding input buffers 72a, 72b and 72c and a rate estimator 74. Although three transraters and three input buffers are shown, it should be understood that more or fewer of these components can be provided in an actual system implementation. A Packet Scheduler 76 is provided which emits packets at the QAM transmission channel rate. In order to transmit packets that go over different IP/UDP transmission channels (different UDP ports), the packet scheduler's output is routed to multiple output queues (i.e., output buffers 82a, 82b, 82c) based on the individual stream's UDP ports by a packet classifier 80.

Since each stream arrives on a different UDP port before reaching the transrater, the routing information (IP/UDP) is tagged to each stream and it is later used by the packet classifier 80 to place the output stream into different queues. This way, after performing the statistical multiplexing and transrating operations on the streams, the streams can still be delivered with the same UDP port parameters, allowing the QAM device to re-multiplex them like before (i.e., as was done when a DBM device was not provided in the network).

In addition to scheduling elementary streams like video and audio, the packet scheduler 76 also needs to generate/modify program specific information (PSI) related information like Program Association Table (PAT) and PMT, which are used by downstream devices, primarily to identify the packet identifier (PID) of each elementary stream.

In a traditional multiplexer, there can be only one Program Association Table that references to multiple program map tables (PMT's). A PAT table has a fixed packet identifier (PID 0), which is first decoded by the downstream device to access the program information of all the programs present in the given multiplex. Since in the present case, the output of the packet scheduler goes to a different queue and the packets are destined for multiple different transmission channels (e.g., different UDP ports) as opposed to only one transmission channel, the packet scheduler 76 needs to generate a PAT table for each channel which contains a reference to a particular PMT. A PAT generator 78 is provided for this purpose. Since the output will be SPTS's, there will be only one PMT reference in a given PAT. Alternatively the original PAT/PMT can be preserved and reinserted/multiplexed into the output of packet scheduler 76 while maintaining the System Target Decoder (STD) buffer model restrictions required by the MPEG specification.

More particularly, the MPEG-2 system standard provides methods for multiplexing a number of elementary MPEG streams into a single system stream. It also defines methods to maintain the synchronization and timing of compressed streams. This is achieved by exact definitions of the times at which data arrive to the decoder, timing of data flow in the decoder and timing of decoding and presentation events. For this purpose, the standard defines a conceptual model for a target decoder (the STD) which is used to model the decoding process. System streams generated by the multiplexer should comply with the specifications imposed by the STD model to guarantee the normal operations of the real time decoding and presentation process.

Traditional multiplexers and packet schedulers also generate Null packets (idle characters) to maintain the fixed channel rate, in case it does not have any packets of actual elementary streams to be scheduled. In the present case, since the output of the packet scheduler 76 goes to multiple transmission channels, the conventional null packet insertion scheme needs to be modified. One option is to drop the null packets from the output of the packet scheduler before packets are placed in their respective output queues. In this case, the final output will not be a fixed channel rate transmission and would become a variable channel rate transmission, i.e., the transport packet rate would not be a fixed rate. Dealing with the VBR transport stream will depend on the capability of the downstream QAM device. It is noted that the current discussion is referring to the transport stream being VBR, meaning a transport stream without null packets, as opposed to VBR video stream encoding.

There can be QAM devices which do not handle VBR transport streams (e.g., from a variable rate transmission channel). It is quite possible that such a QAM device will rely on the CBR nature (fixed transmission channel rate) of the transport stream to recover the Program Clock Reference (PCR) clock. In such cases, the output of the multiplexer needs to be CBR.

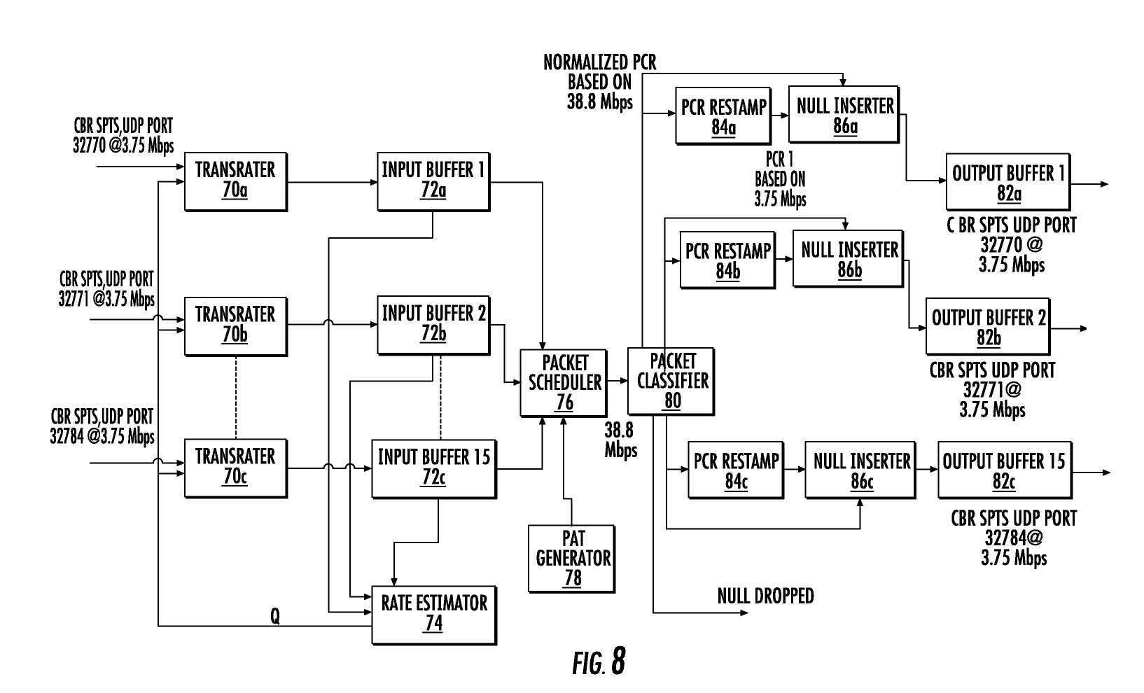

In the embodiment shown in FIG. 8, after the packet scheduler 76 generates the 38.8 Mbps multiplex, the packet classifier 80 demultiplexes the output and sends the packets a separate way. For SPTS 1, the output packets go through a “PCR restamp” module 84a and a corresponding “Null Inserter” module 86a before they are placed in the appropriate output buffer 1, designated by reference numeral 82a. The output of the packet scheduler 76 has the PCR of each program normalized to a common time base based on the 38.8 Mbps rate. The PCR Restamp module 84a corrects/restamps the PCR value so that its output is based on the 3.75 Mbps rate. This can be easily done by keeping track of the number of transport packets delivered to the output buffer for each SPTS. The null inserter module 86a is responsible for making the output CBR. It periodically inserts null packets in the bit stream to maintain the CBR rate. The drain rate of the output buffer 1 can be set to 3.75 Mbps so that it constantly drains packets at that rate.

The null inserter takes PCR1 (which is the restamped PCR for SPTS 1) and compares it with a normalized PCR to figure out how many null packets need to be inserted. Since the output of the packet scheduler is a CBR at 38.8 Mbps, the normalized PCR always gives the notion of current time to the null inserter module. Specifically, by taking the difference between the normalizer PCR and PCR1, and using the CBR rate of 3.75 Mbps, the null inserter module can accurately figure out the number of null packets that need to be generated and inserted. In particular:

npkts=((PCR−PCR1)/Time taken to send 1 packet at 3.75 Mbps)

Of course, the value of PCR and PCR1 is maintained in a common time base. This process ensures that the output of the DBM is a CBR transport stream at 3.75 Mbps. Assuming fifteen streams per QAM modulator and 3.75 Mbps per channel, the incoming 56.25 Mbps rate is transrated to 38.8 Mbps by the packet scheduler. The final output is 56.25 Mbps, meaning the number of null packets inserted is 56.25-38.8=17.45 Mbps. Excluding the null packets, the cumulative rate of the streams does not exceed 38.8 Mbps. This allows the QAM device to multiplex the channels again as long as the QAM device has the capability to drop the null packets.

The same algorithm can be extended to multiple different QAM rates (not just 38.8 Mbps) and can be extended to different VOD stream rates (e.g., for HD the VOD channel rate is typically 15 Mbps). Moreover, as indicated in FIG. 8, multiple channels are provided for different streams, each having a corresponding PCR restamp module 84b, 84c, etc., a corresponding null inserter module 86b, 86c, etc., and a corresponding output buffer 82b, 82c, etc. Any number of channels can be provided for depending on the capacity of the system.

In the manner discussed above, the inventive DBM allows for a seamless architecture that fits in the VOD environment and provides a solution to save bandwidth by “pre stat muxing” and transrating the channels, while delivering them as SPTS.

It should now be appreciated that the present invention provides methods and apparatus for efficiently delivering video-on-demand streams to customers. A significant increase in the number of streams that can be delivered in comparison to prior art schemes is achieved. In order to provide a real-time increase in the number of channels that can be delivered, without re-encoding the VOD streams on the server, a multiplexer or a device that includes transrating capability is utilized to reduce the amount of bandwidth required by individual streams. This device is inserted between the VOD server and the QAM modulator. In particular, the present invention teaches the use of a dynamic bandwidth manager between the VOD server and the QAM modulator. This “DBM” receives incoming unicast single program transport streams and applies statistical multiplexing to (i) transrate them and (ii) optimize the video bandwidth, and then deliver them as single program transport streams.

It is noted that the foregoing descriptions of specific embodiments of the invention are presented for purposes of illustration and description. They are not intended to be exhaustive or to limit the invention to the precise forms disclosed, and various modifications and adaptations are possible in view of the above teachings. Therefore, it is intended that the invention not be limited to the particular embodiments disclosed herein, but that the invention include all embodiments falling within the scope of the appended claims.

What is claimed is:

1. A method for providing a plurality of video on demand (VOD) streams to customers, comprising:
receiving video streams from a VOD server;
statistically multiplexing the received streams to transrate the streams and to optimize their video bandwidth;
modulating the statistically multiplexed streams; and
delivering the multiplexed streams as single program transport streams.

2. A method in accordance with claim 1 wherein:
the streams received from said VOD server comprise unicast single program transport streams; and
the transrated and optimized streams resulting from said statistical multiplexing step are provided for modulation as single program transport streams.

3. A method in accordance with claim 2 wherein:
the streams received from said VOD server are delivered via a User Datagram Protocol (UDP) port; and
the transrated and optimized streams resulting from said statistical multiplexing step are provided for modulation as single program transport streams over the same UDP port.

4. A method in accordance with claim 3 wherein:
said modulating step utilizes a portmap processing scheme to map multiple VOD single program transport streams delivered on different UDP ports to a specific QAM channel and allocate a unique program to each VOD stream based on the map; and
the portmap processing scheme is also used by said statistical multiplexing step.

5. Apparatus for providing a plurality of video on demand (VOD) streams, comprising:
a dynamic bandwidth manager (DBM) for receiving video streams from a VOD server;
a statistical multiplexer within said bandwidth manager for transrating the received streams and optimizing their video bandwidth; and
a modulator for modulating the statistically multiplexed streams for delivery as single program transport streams.

6. Apparatus in accordance with claim 5 wherein the streams received from said VOD server comprise unicast single program transport streams; and
the transrated and optimized streams from said statistical multiplexer are provided to said modulator as single program transport streams.

7. Apparatus in accordance with claim 6 wherein:
the streams received from said VOD server are delivered via a User Datagram Protocol (UDP) port; and
the transrated and optimized streams are provided to said modulator over the same UDP port.

8. Apparatus in accordance with claim 5 wherein said DBM comprises:
a plurality of transraters;
an input buffer associated with each transrater, each input buffer coupled to receive packets from an output of its associated transrater;
a rate estimator coupled to receive information from said input buffers and to provide feedback based thereon to said transraters; and
a packet scheduler for providing packets from said input buffers at a predetermined transmission channel rate.

9. Apparatus in accordance with claim 8 wherein said DBM further comprises:
a packet classifier for receiving the packets from said packet scheduler; and
a plurality of output buffers coupled to receive packets from said packet classifier, each output buffer being associated with a particular User Datagram Protocol (UDP) port;
wherein said packet classifier routes particular packets to particular output buffers based on the UDP port with which a stream carrying the particular packets is associated.

10. Apparatus in accordance with claim 9 wherein:
each stream is carried via the UDP port associated with that stream to one of said transraters for processing; and
said packet classifier uses routing information tagged to each stream to place packets from the stream into the proper output buffer after statistical multiplexing and transrating operations have been performed on the stream.

11. Apparatus in accordance with claim 10 comprising a program association table (PAT) generator associated with said packet scheduler.

12. Apparatus in accordance with claim 9 wherein null packets are dropped from the packets from said packet scheduler before being provided to said output buffers.

13. Apparatus in accordance with claim 9 wherein said packets are provided to said output buffers in a constant bit rate (CBR) transport stream.

14. Apparatus in accordance with claim 13 comprising:
a program clock reference (PCR) restamp module and a null packet inserter associated with each output buffer and coupled to receive packets from said packet classifier for providing said packets at said constant bit rate.
